(19) United States
(12) Patent Application Publication
(10) Pub. No.: US 2026/0337916 A1
(43) Pub. Date: Oct. 29, 2026

(54) WORKING MACHINE

(71) Applicant: J.C. Bamford Excavators Limited, Uttoxeter (GB)

(72) Inventors: Robert Swift, Uttoxeter (GB); David Morris, Uttoxeter (GB)

(21) Appl. No.: 19/657,603

(22) Filed: Apr. 24, 2026

(30) Foreign Application Priority Data
Apr. 24, 2025 (GB) 2506091.4

(51) Int. Cl. E02F 3/28; B66F 9/065; E02F 3/38; E02F 9/22

(52) U.S. Cl. CPC E02F 3/286; B66F 9/0655; E02F 3/38; E02F 9/2275

(57) ABSTRACT

A working machine including a chassis and a telescopically extendable boom pivotably mounted with respect to the chassis and including an outer arm and an inner arm arranged to slide telescopically with respect to each other, each arm including an elongate hollow body defined by first and second lateral walls joined by opposing side walls, and having a chassis end and a tool end opposite to the chassis end, the outer arm including a pivot pin receiving formation adjacent to and spaced from the chassis end of at least one of the lateral walls thereof; the boom further including a first pair of hydraulic lines, configured to be connected in fluid communication with hydraulic equipment spaced from the chassis end of the elongate hollow bodies, each hydraulic line being arranged within the elongate hollow body of the inner arm and each hydraulic line terminating at one end adjacent the chassis end of the elongate hollow body of the inner arm; the hydraulic lines including a first pair of flow elbows arranged within the hollow body at the chassis end of the hydraulic lines and having a respective first port, each flow elbow turning substantially through between 135° and 225° so that the first ports face substantially away from the chassis end; wherein the boom further comprises a pair of flexible hydraulic hoses, each having a boom end and a chassis end, and which extend from a location outside the boom, along a hydraulic hose path which has a first part extending from the space between the chassis end of the first or second lateral wall of the outer arm and the pivot pin receiving formation, into the elongate hollow body of the inner arm, a second part extending from the first part, adjacent to one of the first or second lateral walls, towards the tool end of the body, a third part extending from the second part which bends through substantially 180°, and a fourth part extending from the third part, adjacent to the other of the first or second lateral walls, back towards the chassis end of the body and each being connected at the boom end thereof to the first ports of the respective pair of flow elbows.

### FIELD

The present disclosure relates to a working machine comprising a telescopically extendable boom.

### BACKGROUND

Working machines having a telescopically extendable boom or booms are known. Telescopic wheel loaders and telescopic handlers are two classes of working machine which are equipped with a telescopically extendible boom or booms. Telescopic wheel loaders are typically used for loading and lifting with a telescopic boom being provided to facilitate a greater lifting height and have an operator station located behind the boom for visibility over the boom. In addition, telescopic wheel loaders typically utilize pivot steering for reasons of maneuverability. Telescopic handlers (telehandlers) typically utilize an operator station mounted to one side of a boom and a rigid body with Ackermann-type steering. Both machines are often used on construction sites and in agricultural applications with areas of rough terrain, inaccessible to conventional forklift trucks, and where a greater forward reach is desirable.

Both classes of working machine, telescopic wheel loader and telehandler, have a compact subclass consisting of smaller, usually lower powered, versions which can be useful in circumstances where access is limited or where the load required to be lifted has a lower weight.

In such compact working machines, the telescopic boom is typically commensurately compact, with a smaller cross-sectional area than those equipped to heavier duty telescopic loaders or telehandlers.

Telescopic booms used on such machines typically include an outer arm and an inner arm arranged to slide within the outer arm and a hydraulic extender ram arranged to drive the inner arm slidably in and out of the outer arm. The boom is typically mounted to the working machine at a pivot point and a hydraulically driven tilt ram is arranged between the body of the working machine and the boom to allow the boom to be lifted or lowered about the pivot point. It is generally preferred to arrange the pivot point as high as possible on the boom to minimize the portion of the boom above the pivot, which in turn minimizes the visual obstruction that the boom presents to the driver. A tool carrier or carriage is arranged at the end of the inner arm, which is remote from the working machine. The tool carrier is arranged to carry a variety of tool attachments, for example a shovel, a pallet fork, etc. The tool carrier is mounted pivotally relative to the boom and a hydraulic tool carrier tilt ram is arranged between the boom and tool carrier to effect pivoting of the tool carrier relative to the boom, typically allowing tilting up and down about a horizontal axis. It is also common for the tool carrier to be equipped with an auxiliary hydraulic system to provide hydraulic power, for example, to the tool which it is carrying. The tool carrier tilt ram and the auxiliary hydraulic system require hydraulic lines to pass along the boom back to the working machine to be supplied with hydraulic fluid from the working machine hydraulic system. In working machines with large cross-sectional area booms there is sufficient space inside the boom itself to accommodate the tool carrier tilt ram and those hydraulic lines. At least part of those hydraulic lines must comprise flexible hydraulic hoses to allow the boom to be extended and still supply hydraulic fluid to the tilt ram and auxiliary hydraulic system at the end of the boom. Those hydraulic hoses typically follow a serpentine path inside the boom to allow them to be paid out when the boom is extended and to fold back on themselves when the boom is retracted. It is also helpful for the hydraulic connections of those hydraulic hoses to be accessible for maintenance purposes.

In the compact working machines with booms of a smaller cross-sectional area, there is less space to accommodate the hydraulic lines for the tool carrier tilt ram and the auxiliary hydraulic system of the tool carrier. Consequently, it is usual for those hydraulic lines to be arranged external to the boom. That is less desirable as it exposes those hydraulic lines to the elements and to potential damage due to contact during operation of the working machine. In addition, externally routed hydraulic line may obscure some of the forward view of the tool and its surroundings

It is an object of the present teaching to provide an improved telescopic boom for a working machine.

### SUMMARY

The present teachings provide a working machine according to the appended claims. Optional features are provided by the dependent claims

A first aspect of the teachings comprises a working machine comprising a chassis and a telescopically extendable boom pivotably mounted with respect to the chassis. The boom may comprise an outer arm and an inner arm arranged to slide telescopically with respect to each other. Each arm may comprise an elongate hollow body defined by first and second lateral walls joined by opposing side walls, and may have a chassis end and a tool end opposite to the chassis end. The outer arm may comprise a pivot pin receiving formation adjacent to and spaced from the chassis end of at least one of the lateral walls thereof. The boom may further comprise a first pair of hydraulic lines, configured to be connected in fluid communication with hydraulic equipment spaced from the chassis end of the elongate hollow bodies. Each hydraulic line may be arranged within the elongate hollow body of the inner arm and each hydraulic line terminating at one end adjacent the chassis end of the elongate hollow body of the inner arm. The hydraulic lines may comprise a first pair of flow elbows arranged within the hollow body at the chassis end of the hydraulic lines and having a respective first port. Each flow elbow may turn substantially through between 135° and 225° so that the first ports face substantially away from the chassis end. The boom may further comprise a pair of flexible hydraulic hoses, each having a boom end and a chassis end, and which may extend from a location outside the boom, along a hydraulic hose path which may have a first part extending from the space between the chassis end of the first or second lateral wall of the outer arm and the pivot pin receiving formation, into the elongate hollow body of the inner arm, a second part which may extend from the first part, adjacent to one of the first or second lateral walls, towards the tool end of the body, a third part which may extend from the second part which bends through substantially 180°, and a fourth part which may extend from the third part, adjacent to the other of the first or second lateral walls, back towards the chassis end of the body. Each flexible hydraulic hose may be connected at the boom end thereof to the first ports of the respective pair of flow elbows.

In that way, two hydraulic hoses, for example, to supply hydraulic fluid to opposite ends of a tool carrier tilt ram can be accommodated inside the boom whilst ready access to the fluid connectors of those hydraulic hoses is provided by mounting the first pair of flow elbows at the chassis end of the inner arm. In addition, the use of such elbows allows the direction of flow to be diverted within a compact vertical space to allow improved access for the hoses below. The hoses have improved protection from external damage and do not obscure the forward view of an operator of the tool or an area around the tool/front of the machine in the same way externally routed hoses may do.

Optionally, the first lateral wall is an upper wall and the first part of the hydraulic hose path extends from the space between the chassis end of the upper wall and the pivot pin receiving formation.

Advantageously this path allows for slack to be more easily provided in the hydraulic hose so it can maintain a suitably large radius of curvature across the full range of boom elevations with respect to the chassis.

Optionally, the second lateral wall is a lower wall and the second part of the hydraulic hose path extends adjacent to the lower wall.

This arrangement allows the second part of the hydraulic hose path, which remains static relative to the outer arm to remain lowermost, aided by gravity.

Optionally, the boom comprises a second pair of hydraulic lines, configured to be connected in fluid communication with hydraulic equipment spaced from the chassis end of the elongate hollow bodies. The second pair of hydraulic lines may be arranged within the elongate hollow body of the inner arm and each hydraulic line may terminate at one end adjacent the chassis end of the elongate hollow body of the inner arm. The hydraulic lines may further comprising a second pair of flow elbows arranged within the hollow body at the chassis end of the hydraulic fluid lines and having a respective first port, each elbow turning substantially through between 135° and 225° so that the first ports face substantially away from the chassis end. The boom may further comprise a second pair of flexible hydraulic hoses, each having a boom end and a chassis end, which may extend from a location outside the boom, along the hydraulic hose path and each may be connected at the boom end thereof to the first ports of the respective pair of flow elbows.

In that way, a second pair of hydraulic hoses can be accommodated inside the boom, for example to supply hydraulic fluid to an auxiliary hydraulic system of a tool carrier carried by the boom. Similarly, these hoses have improved protection from external damage and do not obscure the forward view of an operator of the tool or an area around the tool/front of the machine in the same way externally routed hoses may do.

Optionally, the hydraulic lines comprise a first portion extending generally from the chassis end towards the tool end and a second portion comprising the flow elbow. The flow elbow may comprise a second port corresponding to the first port and a fluid passage between the first port and the second port. The first portion may be releasably connected to the second port.

This may simplify the manufacture and installation of the hydraulic fluid lines.

Optionally, at least two of the flow elbows are provided in a first manifold, having a manifold body which defines the first ports, second ports and fluid passages between the first ports and corresponding second ports.

This may offer a compact and robust arrangement of flow elbows.

Optionally, the manifold has a common manifold body defining four sets of first ports, second ports and fluid passages.

This may offer an even more compact and robust arrangement of flow elbows.

Optionally, the four sets of first ports and/or four sets of second ports are substantially aligned transverse to a longitudinal axis of the boom.

This may be especially compact and simple to manufacture.

Optionally, each flow elbow is mounted to one of the lateral walls of the elongate hollow body of the inner arm adjacent to the chassis end thereof.

Such a location is advantageous for installation and/or service access and still allows sufficient space for the hoses to pass into the interior of the boom.

Optionally, each flow elbow is releasably mounted to the one of the lateral walls of the inner arm.

Advantageously, this may further simplify assembly and/or servicing of the boom.

Optionally, each flow elbow is arranged so that the first ports and second ports face generally towards the tool end of the elongate hollow body of the inner arm.

This arrangement is advantageous because the hydraulic fluid lines and hydraulic hoses do not need to bend substantially in the region where they are connected to the flow elbows which increases the space around the flow elbows to allow the passage of the hydraulic hoses.

Optionally, at least one of the hydraulic lines is arranged adjacent one side wall of the elongate hollow body of the inner arm.

Advantageously, this separates the hydraulic line(s) from the hollow body accommodating the flexible hoses, to allow for the free movement of the flexible hoses.

Optionally, two hydraulic lines are arranged adjacent the one side wall and are arranged one above the other.

Advantageously this minimizes the transverse width occupied by the lines, maximizing space for the flexible hoses.

Optionally, the inner arm further comprises a hose guide to separate the hydraulic line from the hydraulic hose path.

Advantageously, this may reduce the risk of the hoses and hydraulic lines rubbing against each other and causing unwanted wear.

Optionally, at least one of the hydraulic lines is arranged adjacent the opposite side wall of the elongate hollow body of the inner arm.

Advantageously, this further separates the hydraulic line(s) from the hollow body accommodating the flexible hoses, to allow for the free movement of the flexible hoses.

Optionally, the inner arm further comprises a second hose guide to separate the hydraulic line from the hydraulic hose path.

Advantageously, this may further reduce the risk of the hoses and hydraulic lines rubbing against each other and causing unwanted wear.

Optionally, a hose tray is provided. The hose tray may comprise an elongate tray body which is secured to the outer arm and which extends into the elongate hollow body of the inner arm adjacent to one of the lateral walls thereof above or beneath the hydraulic hose path. The elongate tray body may be free to slide relative to the inner arm.

Advantageously, this may further protect the flexible hoses from wear during telescoping of the arms.

Optionally, the hoses are secured to the hose tray by means of a first hose clamp arranged adjacent to the chassis end of the outer arm.

By clamping the hoses in this way, the length of the hoses which pass along the second part of the hydraulic hose path is controlled and wear may be minimized.

Optionally, the hoses are secured to the hose tray by means of a hose clamp arranged at a position spaced from the chassis end of the outer arm, for example at a transition between the second part and the third of the hydraulic hose path.

By clamping the hoses in this way, the length of the hoses which pass along the second part of the hydraulic hose path is further controlled and wear may be minimized.

Optionally, the flexible hydraulic hoses are continuous between the fluid connectors at each end thereof.

Continuous lengths of hoses are uninterrupted by joints or connectors along their lengths between the fluid end connectors. Typically such joints are weak points where leakage, wear or entanglement may occur. Thus, providing a continuous lengths may further enhance the durability of the hoses.

Optionally, the hydraulic lines comprise flexible hydraulic hoses.

By utilizing flexible hoses for the hydraulic lines, installation may be simplified and the costs of preparing bespoke rigid lines may be avoided.

Optionally, the pivot pin receiving portion is defined in each of the side walls of the outer arm.

Optionally, the inner boom has an internal height between the upper and lower walls of between approximately 175 mm and 250 mm.

Optionally, the working machine has a mass of up to around 7000 kg.

Optionally, the working machine is a telescopic wheel loader or telehandler, optionally further comprising an operator station. The operator station may be positioned to the rear of the telescopic boom.

An operator operating a machine from this location may be afforded a less interrupted view of a tool attached to the boom, and/or an area around the tool by virtue of the internal routing of hoses in the boom.

### BRIEF DESCRIPTION OF DRAWINGS

Embodiments will now be described by way of example only with reference to the accompanying figures, in which:

FIG. 1a is side sectional view of a telescopic boom in accordance with the teachings taken on the line A-A in FIG. 1b;

FIG. 1b is an end elevation view of the telescopic boom of FIG. 1a looking in the direction of arrow B in FIG. 1a;

FIG. 2a is a view similar to FIG. 1a, showing the boom in an extended state;

FIG. 2b is a view similar to FIG. 1b;

FIG. 3 is a side elevation in the boom in FIGS. 1a and 2a;

FIG. 4a is a cross-sectional view of the boom in FIGS. 1a, 2a and 3 taken on the line C-C in FIG. 3;

FIG. 4b is an enlarged view of the region E in FIG. 4a;

FIG. 5a is a cross-sectional view of the boom in FIG. 3 taken on the line D-D in FIG. 3;

FIG. 5b is an enlarged view of the region F in FIG. 5a;

FIG. 6a is a cross-section through the boom of FIG. 3 taken on the line E-E in FIG. 3;

FIG. 6b is an enlarged view of the region G in FIG. 6a; and

FIG. 7 is a side elevation of a working machine of the present teachings.

### DETAILED DESCRIPTION

In the following detailed description, numerous specific details are set forth in order to provide a thorough understanding of various embodiments and the teachings. However, those skilled in the art will understand that: the present teachings may be practiced without these specific details or with known equivalents of these specific details; that the present teachings are not limited to the described embodiments; and, that the present teachings may be practiced in a variety of alternative embodiments. It will also be appreciated that well known methods, procedures, components, and systems may not have been described in detail.

References to vertical and horizontal in the present disclosure should be understood to be in relation to the machine when stood on horizontal ground in a non-working condition. The term axial is generally used in relation to the longitudinal axis of the machine. The term width is generally used in relation to the longitudinal length, that is, transverse to the length.

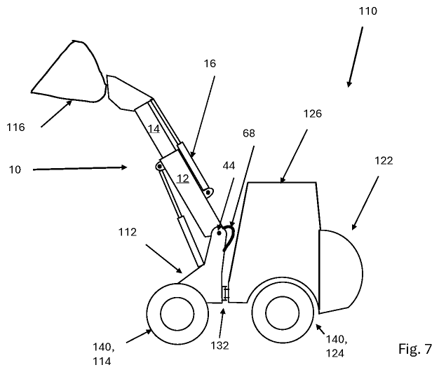

With reference to FIG. 7, a working machine 110 in the form of a telescopic wheel loader is depicted. However, it shall be appreciated that in other embodiments, the teachings may be applied to other forms of working machine, such as telehandlers and mobile elevated work platforms (MEWPs), some forms of which also employ telescopic booms.

The working machine 110 depicted in FIG. 7 comprises a front chassis 112 and a rear chassis 122 which are joined together via an articulated connection 132, allowing the front chassis 112 to pivot relative to the rear chassis 122.

The working machine has a ground engaging structure 140 for moving the working vehicle 110 over the ground. In particular, the ground engaging structure 140 includes a first set of wheels 114 provided on the front chassis 112 for moving the front chassis 112 over the ground. The ground engaging structure 140 also includes a second set of wheels 124 provided on the rear chassis 122 for moving the rear chassis 122 over the ground.

A working arm in the form of a telescopic boom 10 is attached to the front chassis 112. The boom 10, which is pivotally attached to the front chassis 112 about a horizontal axis, mounts an implement or tool 116 which is pivotally attached to a free end of the boom 10. In the illustrated embodiment, the tool 116 is a shovel. In other embodiments, the tool may be a fork or grab, by way of non-limiting example.

The working machine 110 also includes a prime mover (not shown in FIG. 7) mounted to the rear chassis 122. An operator station in the form of a cab 126 is further mounted to the rear chassis 122 forward of the prime mover. The cab 126 is provided with a collection of controls (not shown) for moving the working arm 10, maneuvering the working vehicle 110 and/or controlling other functions of the working vehicle 110.

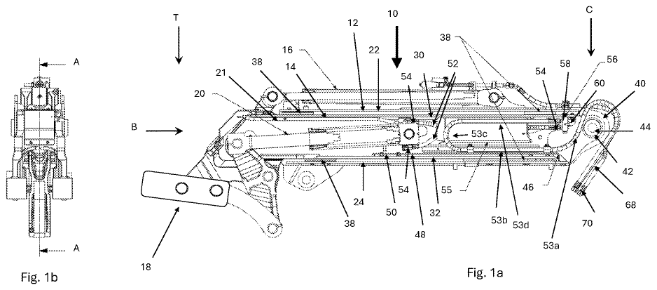

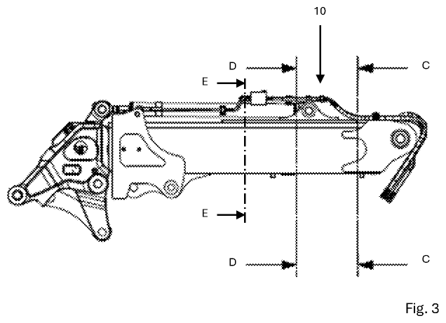

Referring to FIG. 1a, the telescopic boom 10 comprises an outer arm 12 and inner arm 14 arranged slidably within the outer arm 12. A hydraulically actable extender actuator or ram 16 is arranged between the outer arm 12 and the inner arm 14. The arms 12, 14 have a chassis end C, which in FIGS. 1a, 2a and 3 is on the right, and a tool end T, which in FIGS. 1a, 2a and 3 is on the left. A tool carrier 18 is mounted to the inner arm 14 at the tool end T thereof. A hydraulically actable tool carrier tilt ram 20 is arranged inside the inner arm 14 and is mounted between the inner arm 14 and the tool carrier 18. The tilt ram 18 is dual-acting and therefore requires a bi-directional hydraulic supply to be provided to each end of the of the body of the ram 20. The tool carrier 18 is fitted with an auxiliary hydraulic system (not shown), which is supplied with hydraulic fluid via two auxiliary hydraulic supply lines 21 (one of which is shown in FIG. 1a), again which supply lines are required to be bi-directional for supply and return to dual-acting actuators provided on tools. The auxiliary hydraulic supply line 21 extends inside the inner arm 14 from approximately the mid-point to the boom end thereof and (not shown) on to the auxiliary hydraulic system (for example to quick-release couplings to which auxiliary hoses of a tool mounted to the tool carrier 18 may be connected).

The outer arm 12 has lateral walls, being an upper wall 22, an opposite lower wall 24 joined by a first side wall 26 and an opposite second side wall 28. The upper, lower and opposite side walls 22, 24, 26, 28 define an interior, rectangular space which is greater in height and width than the external height and width of the inner arm 14. In that way, the inner arm 14 can be received slidably within the outer arm 12.

The inner arm also has lateral walls, being an upper wall 30, an opposite lower wall 32 joined by first and opposite second side walls 34, 36.

The extender ram 16 is mounted at one end thereof to the exterior of the upper wall of the outer arm 12 at a position close to the chassis end C of the upper wall 22 of the outer arm 12, slightly spaced towards the tool end T of the upper arm. The other end of the extender ram 16 is mounted to the upper wall 30 of the inner arm 14 adjacent to the tool end T thereof.

The inner arm 14 has two sets of wear pads 38 which are mounted to the exterior of the inner arm 14 for the set at the chassis end C and on the interior of the outer arm for the set at the tool end T in a conventional manner. The wear pads 38 take up the space between the inner surface of the walls 22, 24, 26,28 of the outer arm 12 and the outer surface of the walls 30, 32, 34, 36 of the inner arm 14 to centralize the position of the inner arm within the outer arm and to facilitate the telescopic sliding movement of the inner arm relative to the outer arm. Wear pads 38 are made of a material which is durable and which facilities the sliding movement.

The tool carrier tilt ram 20 is arranged inside the inner arm 14 and is mounted at one end thereof at a position approx. midway between the chassis end C and tool end T of the inner arm 14. The other end of the tool carrier tilt ram is mounted to the tool carrier 18 via a known linkage. One of the auxiliary hydraulic supply lines 21 extends adjacent the first side wall 34 of the inner arm 14 and the other extends adjacent the second side wall 36 of the inner arm.

The opposite first and second side walls 26, 28 of the outer arm 12 each include a pivot pin receiving formation 40 at the chassis end of the outer arm 12. Each pivot pin receiving formation 40 defines an aperture 42 arranged to receive one end of a pivot pin 44. The pivot pin receiving formations 40 extend further beyond the chassis end of the upper wall 22 of the outer arm 12 so that a space is defined between the pivot pin aperture 42 and the chassis end of the upper wall 22 of the outer arm 12. The pivot pin apertures 42 define the position of the pivot pin 44 relative to the boom 10. In this embodiment, the pivot pin is located lower relative to the boom and spaced further away from the chassis end of the upper wall of the outer arm 12 than in conventional booms. That is to say that a greater proportion of the structure of the boom 10 is above the pivot pin 44 than in conventional booms. This arrangement facilitates the hydraulic hose path described below.

A hose tray 46 is mounted at one end thereof to the chassis end of the lower wall 24 of the upper arm 12. The hose tray 46 comprises an elongate tray body 48 which may be lipped upwardly about its periphery. The tray body extends from the mounting of the hose tray into the inner arm 14, parallel with the lower wall 32 of the inner arm 14. A tray slide 50 is mounted to the underside of the tray body 48 at the tool end T thereof so as to facilitate sliding of the hose tray 46 relative to the inner arm 12.

Two pairs of hydraulic lines 52 are arranged inside the inner arm 14 in this embodiment. Each hydraulic line 52 extends from the chassis end C of the inner arm 14 towards the tool end of the inner arm 14. Each pair of hydraulic lines 52 extends adjacent to a respective one of the first and second opposite side walls 34, 36 of the inner arm 14. Each hydraulic line 52 includes a fluid connector 54 at each end thereof. The hydraulic lines are flexible hoses in this embodiment, but may be rigid pipes, or a combination of flexible hoses and rigid pipes in other embodiments.

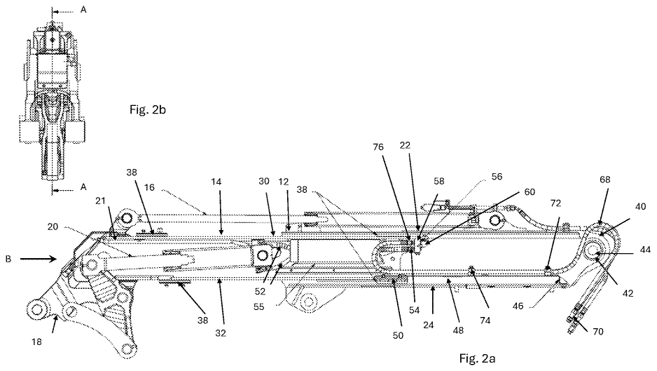

The first pair of hydraulic lines 52 (shown in FIGS. 1a and 2a) extend adjacent the first side wall 34 of the inner arm 14. The first pair of hydraulic lines 52 are respectively connected at their ends spaced from the chassis end C to a head end of the tool carrier tilt ram 20 and to an end of one of the auxiliary hydraulic supply lines 21 by means of the respective fluid connectors 54.

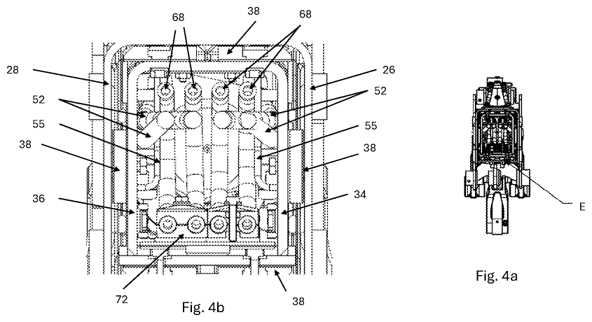

The second pair of hydraulic lines 52 (see FIG. 4b) extend adjacent the second side wall 36 of the inner arm 14. The second pair of hydraulic lines 52 are respectively connected at their ends spaced from the chassis end C to a rod end of the tool carrier tilt ram 20 and to an end of the other of the auxiliary hydraulic supply lines 21 via the respective fluid connectors 54.

Respective hose guides 55, each comprising an elongate plate, L-shaped in cross section, are mounted inside the inner arm 14 adjacent to but spaced from respective side walls 34, 36 of the inner arm and running from the chassis end C of the inner arm 14 to a point just short of the tool carrier tilt ram 20. The first and second pairs of hydraulic lines 52 extend, respectively, in the space between the hose guide 55 and respective side wall 34, 36.

A flow elbow in the form of a fluid manifold 56, which may be regarded as a part of the hydraulic lines 52 is mounted to the underside of the upper wall 30 of the inner arm 14 at the chassis end C thereof.

The fluid manifold 56 comprises a manifold body 58 which is mounted to a manifold mounting bracket 60, the manifold mounting bracket 60 being mounted to the underside of the upper wall 30 of the inner arm 14. In this embodiment the mounting is via releasable fasteners, such as bolts, for ease of installation and removal

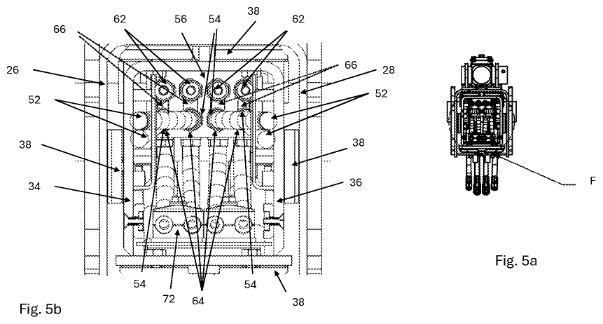

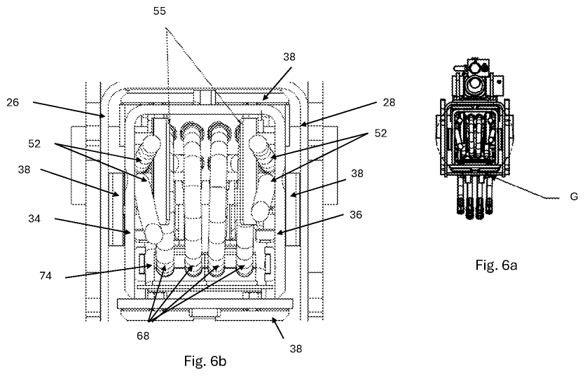

The manifold body 58 defines a first array of four fluid ports 62 and a second corresponding array of four fluid ports 64, respective pairs of fluid ports 62, 64 in the first and second arrays being interconnected in fluid communication by respective fluid passages 66 which passages turn through substantially 180° so that all of the fluid ports in the first and second arrays face in the same direction. The fluid passages 66 are represented by broken lines in FIG. 5b. It will be appreciated that each first port 62 is fluidly connected to its corresponding single second port 64 only. In this embodiment the manifold body 58 is a rigid single block e.g., of metal in which the passages 66 are formed via suitable machining operations, but in other embodiments this may not be the case.

Manufacturing the manifold body 58 in this way minimizes its vertical height as the vertical spacing between the respective pairs of fluid ports is dictated by minimum clearances around the ports to fit the respective connectors, rather than by minimum bend radii of flexible hoses, for example. It can therefore be seen that in this embodiment, the manifold body occupies less than half the vertical height between the upper and lower walls 30, 32, providing further space for routing pipework and/or for maintenance access.

As shown in FIG. 5b, all four fluid connectors 54 at the chassis end C of the first and second pairs of hydraulic lines 52 are connected in fluid communication with the second array of fluid ports 64 of the manifold 56.

By spacing the pivot pin 44 apart from the chassis end C of the upper wall 22 of the outer arm 12, by locating the manifold 56 at the chassis end of the inner arm 14 and by arranging the hydraulic lines 52 adjacent the side walls 34, 36 of the inner arm 14 behind the hose guides 55, space is provided for routing hydraulic hoses. A hydraulic hose path followed by four flexible hoses 68 is defined which has a first part 53a extending from the space between the chassis end of the upper wall of the outer arm 12 and the pivot pin, down into the elongate hollow body of the inner arm 14, a second part 53b extending from the first part, adjacent to the lower wall, towards the tool end of the body, a third part 53c extending from the second part which bends through 180°, and a fourth part 53d extending from the third part, adjacent to the upper wall, back towards the chassis end C of the body and terminating at the first ports 62 of the manifold 56.

The flexible hoses 68 have a chassis end equipped with fluid connectors 70, which, in use, are connected to the hydraulic system of the working machine 110.

The hoses 68 extend from the connection to the hydraulic system, up and over the pivot pin 44, and, following the first part 53a of the hose path, loop down through the space between the pin 44 and the chassis end of the upper wall 22 of the outer arm 12 of the boom 10 into the interior of the boom.

The hoses 68 are clamped to the hose tray 46 side-by-side by means of first hose clamps 72, at the chassis end of the hose tray. Following the second part 53b of the hose path, the hoses 68 extend along the hose tray 46 towards the tool end of the hose tray. The hoses 68 are clamped to the hose tray 46 by means of second hose clamps 74, approximately at the mid-point of the hose tray.

As shown in FIG. 1a, the hoses 68 then bend upwardly through 180°, following the third part of the hose path 53c side-by-side.

Finally, following the fourth part of the hose 53d, the hoses 68 extend side-by-side parallel with and adjacent to the underside of the upper wall 30 of the inner arm 14, terminating in fluid connectors 76, which are connected to the first array of fluid ports 62 in the manifold 56. It can be seen from FIG. 2a that the fluid connectors 76 connect to the first ports 62 which are above the second ports 64 on the manifold 56. This also allows for more space to accommodate the bend in the flexible hoses 68.

The hoses 68 are continuous and uninterrupted between the chassis end fluid connectors 70 and the fluid connectors 76 connected to the manifold 56. Put another way, there are no intermediate joints or connectors between these locations. As such joints are a potential source of leaks, this reduces the risk of leaks occurring within the boom 10.

FIG. 1a shows the boom in a retracted state. In the retracted state, the third part 53a of the hose path (the 180° bend) commences adjacent the second hose clamps 74.

FIG. 2a shows the boom 10 in an extended state. In the extended state, the hoses 68 have been paid out along substantially the whole length of the hose tray 46 so that the third part 53c of the hose path commences adjacent the end of the hose tray 46 and there is a considerably shorter run of hose 68 along the fourth part 53d of the path to the manifold 56.

The hose guides 55 inhibit the hoses 68 from getting caught on the hydraulic lines 52 as the hoses 68 are furled and unfurled during retraction and extension of the boom.

By arranging the manifold 56 at the chassis end of the inner arm, all eight of the fluid connections between the hoses 68 and the hydraulic lines 52 are readily accessible for maintenance and service purposes. By providing that the fluid ports on the manifold 56 all face in the same direction, unnecessary bends in both the hoses and lines are avoided. Hydraulic flexible hoses and lines have minimum bend radii to avoid kinking or damage and so reducing the number of bends which the hoses and lines have to follow increases the space available in the region of the manifold 56, which in turn allows passage of the hoses from the exterior to the interior of the boom 10.

The arrangement described allows the hydraulic lines and hoses 52, 68 to supply the tool carrier tilt ram 20 and auxiliary hydraulic system of the tool carrier 18 to be accommodated inside the arms 12, 14 of a compact working machine 110, whilst still allowing ready access to the fluid connectors of the lines and hoses for maintenance and/or servicing. The internal routing of the lines 52 and hoses 68 offers greater protection from external damage and also is less prone to obscure or inhibit a view forward of the tool attachment and/or area surrounding the front of the working machine 110.

Should any of the hoses 68 nevertheless require replacement this may achieved by disconnecting the fluid connects 70, 76, which are accessible at least with the boom 10 retracted. In addition the hose clamps 72 and 74 within the inner arm 12 require release by undoing retaining bolts. These can be reached with a standard tool, such a ratchet type socket wrench, via a space defined between the pivot pin 44 and lower wall 32. As a result, no disassembly of the boom 10 itself is required, saving maintenance time.

In another embodiment (not shown), instead of a common manifold body having first and second arrays of four fluid ports, two separate manifold bodies are provided, each having first and second arrays of two fluid ports. In that case, both manifold bodies are mounted at the chassis end of the inner arm, one adjacent one side wall 34 of the inner arm 14 and the other adjacent the opposite side wall 36 of the inner arm with a space between the two bodies. As with the single body version, the manifold bodies are arranged such that all of the fluid ports face generally towards the tool end of the inner arm.

In a still further embodiment (not shown), the manifold is replaced by flow elbows in the form of individual U-bend rigid pipes, each having fluid ports at opposite ends and a pipe body which turns through substantially 180°. In such a case, the U-bend pipes are mounted at the chassis end of the inner arm 14 such that all of the fluid ports face generally towards the tool end of the inner arm.

In this embodiment the internal height between the upper and lower walls 30, 32 is 189 mm and the hoses 68 have a ⅜″ (9.5 mm) bore. A typical minimum bend radius of a ⅜″ hose is 60 mm, so this internal height allows ample space for to accommodate the 180° bend in the hoses 68. Compact telehandlers and telescopic wheel loaders typically are considered to have an internal height of the inner arm 14 of between 175 mm and 250 mm. Compact telescopic wheel loaders having an inner arm of this height range typically have a mass of up to 7000 kg.

The one or more embodiments are described above by way of example only and it will be appreciated that the variations are possible without departing from the scope of protection afforded by the appended claims. For example, the first part of the hydraulic hose path may extend between the pivot pin receiving portion and the lower wall 24 of the outer arm. The second and fourth parts 53b and 53d may be inverted so the second part extends adjacent to the upper wall 30 and the flow elbows 58 may be positioned adjacent to the chassis end of the lower wall 32. In this embodiment the first part may extend between the pivot pin receiving portion and either the upper wall 22 or the lower wall 24. In embodiments where the second and fourth parts 53b, 53d are inverted, the hose tray 46 may be stiffened to support its self-weight and the weight of the hoses and/or guide supports may be provided on the side walls 34, 36 of the inner arm 14 to support it.

1. A working machine comprising:
a chassis; and
a telescopically extendable boom pivotably mounted with respect to the chassis and comprising an outer arm and an inner arm arranged to slide telescopically with respect to each other,
each arm comprising an elongate hollow body defined by first and second lateral walls joined by opposing side walls, and having a chassis end and a tool end opposite to the chassis end,
the outer arm comprising a pivot pin receiving formation adjacent to and spaced from the chassis end of at least one of the lateral walls thereof;
the boom further comprising a first pair of hydraulic lines, configured to be connected in fluid communication with hydraulic equipment spaced from the chassis end of the elongate hollow bodies, each hydraulic line being arranged within the elongate hollow body of the inner arm and each hydraulic line terminating at one end adjacent the chassis end of the elongate hollow body of the inner arm;
the hydraulic lines comprising a first pair of flow elbows arranged within the hollow body at the chassis end of the hydraulic lines and having a respective first port, each flow elbow turning substantially through between 135° and 225° so that the first ports face substantially away from the chassis end;
wherein the boom further comprises a pair of flexible hydraulic hoses, each having a boom end and a chassis end, and which extend from a location outside the boom, along a hydraulic hose path which has a first part extending from the space between the chassis end of the first or second lateral wall of the outer arm and the pivot pin receiving formation, into the elongate hollow body of the inner arm, a second part extending from the first part, adjacent to one of the first or second lateral walls, towards the tool end of the body, a third part extending from the second part which bends through substantially 180°, and a fourth part extending from the third part, adjacent to the other of the first or second lateral walls, back towards the chassis end of the body and each being connected at the boom end thereof to the first ports of the respective pair of flow elbows.

2. The working machine of claim 1, wherein the first lateral wall is an upper wall and the first part of the hydraulic hose path extends from the space between the chassis end of the upper wall and the pivot pin receiving formation.

3. The working machine of claim 1, wherein the second lateral wall is a lower wall and the second part of the hydraulic hose path extends adjacent to the lower wall.

4. The working machine of claim 1, wherein the boom comprises a second pair of hydraulic lines, configured to be connected in fluid communication with hydraulic equipment spaced from the chassis end of the elongate hollow bodies, being arranged within the elongate hollow body of the inner arm and each hydraulic line terminating at one end adjacent the chassis end of the elongate hollow body of the inner arm,
the hydraulic lines further comprising a second pair of flow elbows arranged within the hollow body at the chassis end of the hydraulic fluid lines and having a respective first port, each elbow turning substantially through between 135° and 225° so that the first ports face substantially away from the chassis end,
and the boom further comprising a second pair of flexible hydraulic hoses, each having a boom end and a chassis end, which extend from a location outside the boom, along the hydraulic hose path and each being connected at the boom end thereof to the first ports of the respective pair of flow elbows.

5. The working machine of claim 1, wherein the hydraulic lines comprise a first portion extending generally from the chassis end towards the tool end and a second portion comprising the flow elbow and wherein the flow elbow comprises a second port corresponding to the first port and a fluid passage between the first port and the second port, the first portion being releasably connected to the second port.

6. The working machine of claim 5, wherein at least two of the flow elbows are provided in a first manifold, having a manifold body which defines the first ports, second ports and fluid passages between the first ports and corresponding second ports, optionally wherein manifold has a common manifold body defining four sets of first ports, second ports and fluid passages, optionally wherein the four sets of first ports and/or four sets of second ports are substantially aligned transverse to a longitudinal axis of the boom.

7. The working machine of claim 1, wherein each flow elbow is mounted to one of the lateral walls of the elongate hollow body of the inner arm adjacent to the chassis end thereof, optionally wherein each flow elbow is releasably mounted to the one of the lateral walls of the inner arm.

8. The working machine of claim 1, wherein each flow elbow is arranged so that the first ports and second ports face generally towards the tool end of the elongate hollow body of the inner arm.

9. The working machine of claim 1, wherein at least one of the hydraulic lines is arranged adjacent one side wall of the elongate hollow body of the inner arm.

10. The working machine of claim 9, wherein two hydraulic lines are arranged adjacent the one side wall and are arranged one above the other.

11. The working machine of claim 9, wherein the inner arm further comprises a hose guide to separate the hydraulic line from the hydraulic hose path.

12. The working machine of claim 9, wherein at least one of the hydraulic lines is arranged adjacent the opposite side wall of the elongate hollow body of the inner arm, optionally wherein the inner arm further comprises a second hose guide to separate the hydraulic line from the hydraulic hose path.

13. The working machine of claim 1, wherein a hose tray is provided, the hose tray comprising an elongate tray body which is secured to the outer arm and which extends into the elongate hollow body of the inner arm adjacent to one of the lateral walls thereof above or beneath the hydraulic hose path, the elongate tray body being free to slide relative to the inner arm.

14. The working machine of claim 13, wherein the hoses are secured to the hose tray by a first hose clamp arranged adjacent to the chassis end of the outer arm, and/or optionally wherein the hoses are secured to the hose tray by a hose clamp arranged at a position spaced from the chassis end of the outer arm, for example at a transition between the second part and the third of the hydraulic hose path.

15. The working machine of claim 1, wherein the flexible hydraulic hoses are continuous between the fluid connectors at each end thereof.

16. The working machine of claim 1, wherein the hydraulic lines comprise flexible hydraulic hoses.

17. The working machine of claim 1, wherein the pivot pin receiving portion is defined in each of the side walls of the outer arm.

18. The working machine of claim 1, wherein the inner boom has an internal height between the upper and lower walls of between 175 mm and 250 mm.

19. The working machine of claim 1, wherein the working machine has a mass of up to 7000 kg.

20. The working machine of claim 1, wherein the working machine is a telescopic wheel loader or telehandler, optionally further comprising an operator station, the operator station being positioned to the rear of the telescopic boom.
